(19) United States
(12) Patent Application Publication
(10) Pub. No.: US 2004/0030782 A1
(43) Pub. Date: Feb. 12, 2004

(54) Method and apparatus for deriving computer system configuration

(76) Inventor: Yasuhiro Nakahara, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/606,227

(22) Filed: Jun. 26, 2003

(30) Foreign Application Priority Data
Jun. 26, 2002 (JP) 2002-186335

(51) Int. Cl. G06F 1/00; G06F 15/173

(52) U.S. Cl. 709/226; 708/100

(57) ABSTRACT

A computer system configuration having a minimum cost is decided automatically in a short time from the computer system configurations having necessary processing performance. The system configuration is expressed by four parameters (performance of CPU, number of CPUs, main memory capacity and I/O processing speed) and the four parameters with which the cost can be minimized are derived by utilizing the numerical analysis method using the method of undetermined multipliers of Lagrange or the like under predetermined constraints concerning a response time of transaction processing. On the other hand, the number of jobs which one CPU provided in the system can execute simultaneously is optimized. The system configuration in which the probability having the response time equal to or longer than A is equal to or lower than B and the cost is minimum is derived.

### BACKGROUND OF THE INVENTION

The present invention relates to a method and an apparatus for deriving a system configuration of a computer and more particularly to computer system configuration deriving method and apparatus for deciding a system configuration of a computer which guarantees predetermined processing performance for transaction processing.

Generally, in the transaction processing performed by the computer system, it is often required that a time (response time) from issuing of a processing request to the system to end of its processing is within a permissible range.

Accordingly, for example, a queuing theory is known as a theory for predicting the response time of processing. The theory is often used to predict an average response time on the basis of an average service time and an arrival rate of processing requests.

Usually, the performance design (capacity planning) of a computer is made by a specialist of its technical field who utilizes knowledge based on his experience and theories such as the queuing theory or the like to select a system configuration satisfying required performance conditions.

### SUMMARY OF THE INVENTION

The above-mentioned method can construct a system that guarantees predetermined performance required by the user, although the above-mentioned method has a problem that it is difficult to select a system having a minimum cost from systems that guarantee the predetermined performance and it takes considerable time and labor if possible.

The reason causing the above problem is that generally there are a large number of combinations of processing performance of CPU, the number of CPUs, a capacity of a main memory, a processing speed of I/O and the like required to be considered in order to derive the system configuration that realizes the predetermined performance. Particularly, when the response time of the system required to guarantee a fixed response time is increased, it is required that the countermeasure for improving the performance of the system is performed as quickly as possible and the optimal system configuration is derived in a short time, although there is a problem that the above-mentioned method cannot cope with such requirements.

Further, when a condition is attached to the response time and the predetermined performance is guaranteed, it is proper that restriction is given to the probability that the response time is equal to or longer than a fixed value as compared with the case where restriction is given to an average response time when it is considered that the number of requests reached per unit time is varied about the average number of reached requests. The reason thereof is that an impermissible response time exists with an impermissible frequency even if the average response time is short. The above-mentioned method does not take such points into consideration.

It is an object of the present invention to solve the problems in the above-mentioned method by providing computer system configuration deriving method and apparatus capable of deciding a computer system configuration having requisite processing performance and minimum cost automatically in a short time.

According to the present invention, the above object is achieved by predicting a response time from issuing of a processing request to end of its processing on the basis of an occurrence frequency of processing requests to computer systems and computer system configurations, calculating costs of the system configurations on the basis of the system configurations, and deriving a cheapest system configuration from the system configurations having a probability equal to or lower than B with respect to a given response time A and a probability B given as a probability of processing having a response time equal to or longer then A for all the processing requests.

More particularly, according to the present invention, there are provided the function that the method of predicting the response time on the basis of the queuing theory is utilized to predict the response time of the processing request on the basis of job data showing properties of job executed by the computer system to be performance-guaranteed, an arrival rate of processing requests and data of system configuration elements such as performance of CPU and memory capacity of the system and the function of calculating costs of system configuration from a cost table of the system configuration elements and the system configuration (optimal system configuration) of the computer system having the minimum cost can be derived in a short time by cooperation of the two functions from the systems which guarantee predetermined processing performance and realize the performance in accordance with the designation method that “the probability of processing having the response time from issuing of the processing request to end of its processing equal to or longer than A is reduced to be equal to or lower than B”.

Deriving of the optimal system configuration as described above is realized by grasping the probability having the response time equal to or longer than a fixed time and a total cost of the system as a function of processing performance of CPU, the number of CPUs, a memory capacity and the like which are a parameter set for deciding the system configuration and by deciding parameters with which the cost function is minimum from subspace or subset of system parameter space having the response time equal to or longer than the fixed time.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram schematically illustrating a configuration deriving system including a computer system configuration deriving apparatus according to a first embodiment of the present invention;

FIG. 2 is a diagram for explaining structure of job data stored in a job data memory unit 107;

FIG. 3 is a flowchart showing processing operation of a configuration deriving unit 102;

FIG. 4 is a flowchart showing processing operation of a virtual page reference interval probability distribution calculation unit in step S304 of FIG. 3;

FIG. 5 is a flowchart showing processing operation of deriving an optimal solution in step S307 of FIG. 3;

FIG. 6 is a diagram for explaining structure of system configuration data stored in a system configuration memory unit;

FIG. 7 is a diagram for explaining structure of cost data stored in a cost data memory unit;

FIG. 8 is a graph showing an example of probability distribution of virtual page reference interval probability;

FIG. 9 is a graph showing an example of relation of performance and cost;

FIG. 10 is a flowchart (part 1) showing processing operation of the configuration deriving unit in a second embodiment of the present invention;

FIG. 11 is a flowchart (part 2) showing processing operation of the configuration deriving unit in the second embodiment of the present invention;

FIG. 12 is a flowchart showing processing of calculating the number of simultaneously-executed jobs in step S1008 of FIG. 11;

FIG. 13 is a block diagram schematically illustrating a third embodiment of the present invention in case where computers to be performance-guaranteed include preliminary system configuration elements;

FIG. 14 is a block diagram schematically illustrating a fourth embodiment of the present invention in case where one computer to be performance-guaranteed is constituted by a plurality of sub-systems;

FIG. 15 is a flowchart (part 1) showing processing operation of a system change instructing unit in the fourth embodiment of the present invention;

FIG. 16 is a flowchart (part 2) showing processing operation of the system change instructing unit in the fourth embodiment of the present invention;

FIG. 17 is a flowchart (part 3) showing processing operation of the system change instructing unit in the fourth embodiment of the present invention;

FIG. 18 is a timing chart showing processing of adding sub-systems in the flows shown in FIGS. 15 to 17;

FIG. 19 is a timing chart showing processing of deleting sub-systems described in FIG. 16; and

FIG. 20 is a diagram showing structure of a sub-system table used in the fourth embodiment.

### DESCRIPTION OF THE EMBODIMENTS

Embodiments of a method and apparatus for deriving a computer system configuration according to the present invention are now described in detail with reference to the accompanying drawings.

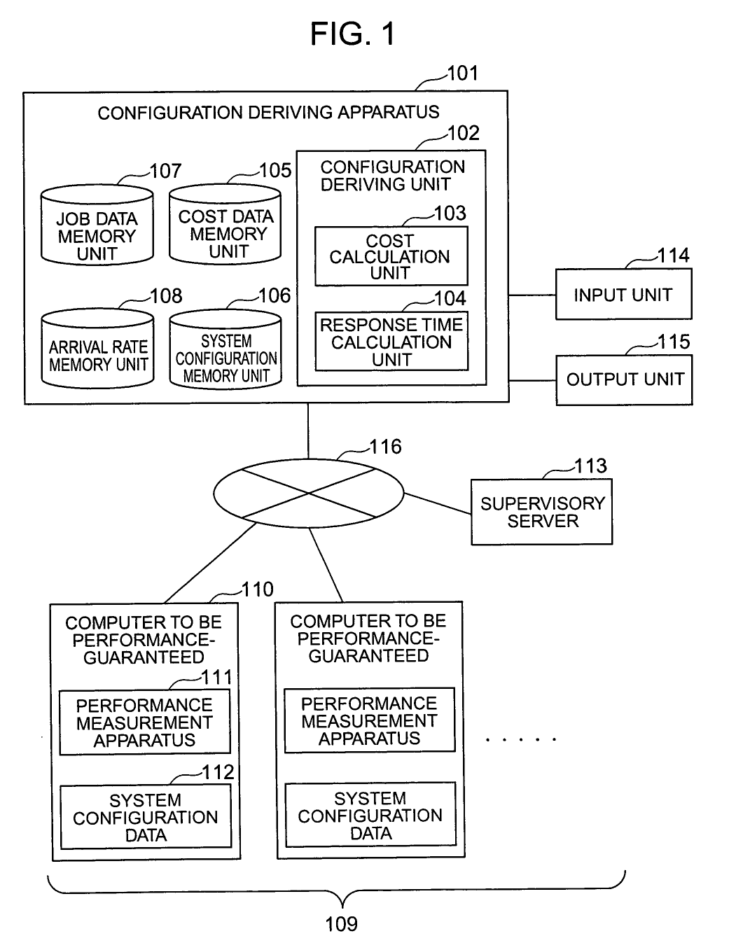

FIG. 1 is a block diagram illustrating a configuration of a configuration deriving system including a computer system configuration deriving apparatus according to a first embodiment of the present invention. In FIG. 1, numeral 101 denotes a configuration deriving apparatus, 102 a configuration deriving unit, 103 a cost calculation unit, 104 a response time calculation unit, 105 a cost data memory unit, 106 a system configuration memory unit, 107 a job data memory unit, 108 an arrival rate memory unit, 109 a computer group to be performance-guaranteed, 110 a computer to be performance-guaranteed, 111 a performance measurement apparatus, 112 system configuration data, 113 a supervisory server, 114 an input unit, 115 an output unit and 116 a network.

The configuration deriving system illustrated in FIG. 1 includes the configuration deriving apparatus 101, the supervisory server 113 and the computer group 109 to be performance-guaranteed composed of one or plurality of the computers 110 to be performance-guaranteed, which are connected to one another through the network 116. The configuration deriving apparatus 101 includes the configuration deriving unit 102, the cost data memory unit 105, the system configuration memory unit 106, the job data memory unit 107 and the arrival rate memory unit 108. The configuration deriving unit 102 includes the cost calculation unit 103 and the response time calculation unit 104. Further, the configuration deriving apparatus 101 is connected to the input unit 114 and the output unit 115.

The computers 110 to be performance-guaranteed constituting the computer group 109 to be performance-guaranteed each constitute a computer system for performing transaction processing in response to a processing request to be reached. The computers 110 to be performance-guaranteed constituting the computer group 109 each include the system performance measurement apparatus 111 and the system configuration data 112.

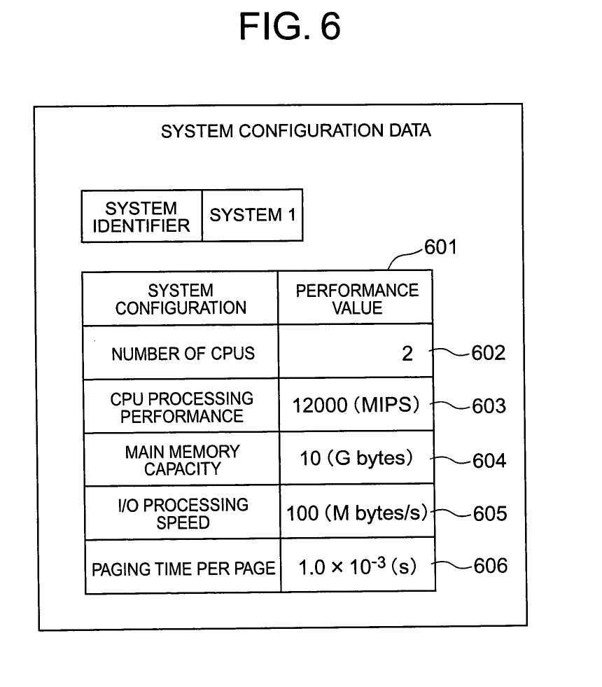

The performance measurement apparatus 111 of the computer 110 obtains information (hereinafter referred to as time-ordered referenced virtual pages data) representing identifiers (virtual page number) of virtual pages in a virtual memory system to be referred by execution of job in the time-ordered manner and measures a CPU processing time in the execution of job and an I/O processing time except paging processing. Further, the system configuration data 112 includes information concerning processing performance of CPU, the number of CPUs, main memory capacity, I/O processing speed and paging time per virtual page as described later with reference to FIG. 6.

The supervisory server 113 collects the system configuration data 112, the time-ordered referenced virtual pages data outputted by the performance measurement apparatus 111, CPU processing time data required for one execution of job and I/O processing time data from each of the computers 110 to be performance-guaranteed connected through the network 116 and transfers the collected data to the configuration deriving apparatus 101. Furthermore, the supervisory server 113 measures the number of processing requests (arrival rate) per unit time to each of the computers to be performance-guaranteed at regular intervals and transfers the arrival rate data to the configuration deriving apparatus 101.

The configuration deriving apparatus 101 receives the arrival rate data transferred from the supervisory server 113 at regular intervals and stores the data in the arrival rate memory unit 108.

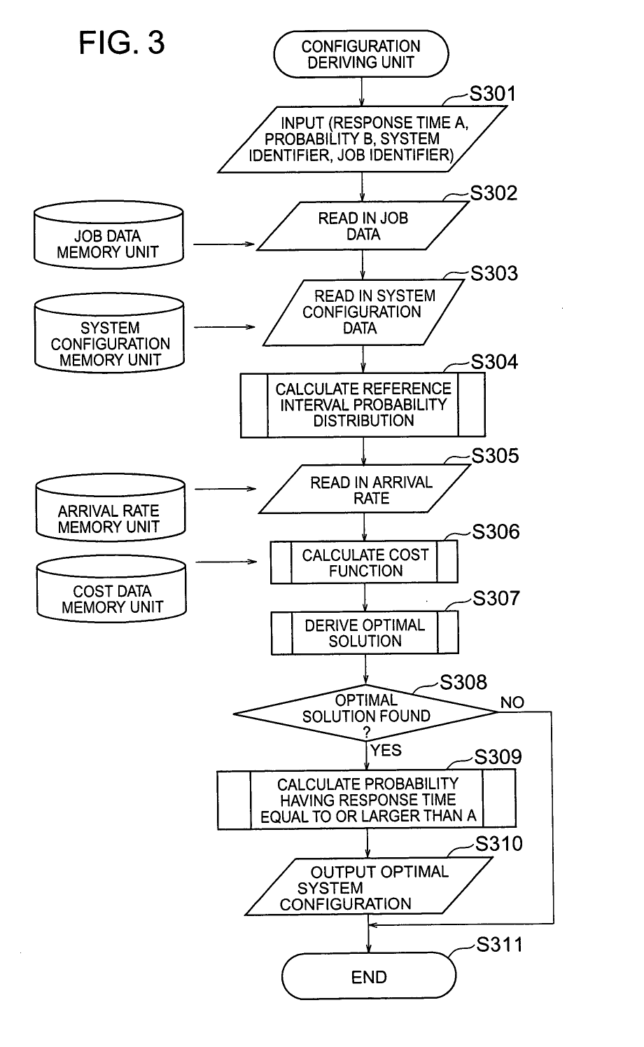

The configuration deriving unit 102 includes the cost calculation unit 103 and the response time calculation unit 104 and causes the cost calculation unit 103 and the response time calculation unit 104 to cooperate with each other functionally to thereby derive the optimal computer system configuration. Detailed processing of the configuration deriving unit 102 is described later with reference to the flowchart shown in FIG. 3.

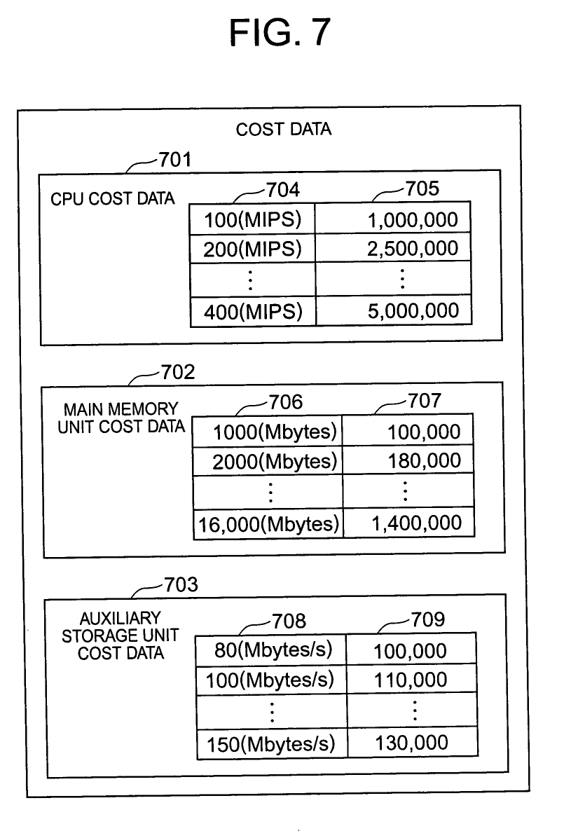

FIG. 7 shows structure of cost data stored in the cost data memory unit 105. The cost data stored in the cost data memory unit 105 is cost information corresponding to performance of system configuration elements and includes tables for CPU cost data 701, main memory unit cost data 702 and auxiliary storage unit cost data 703. The CPU cost data 701 includes CPU performance data 704 and cost data 705 of the CPU performance. The main memory unit cost data 702 includes main memory unit capacity data 706 and cost data 707 of the main memory unit. The auxiliary storage unit cost data 703 includes I/O processing speed data 708 of the auxiliary storage unit and cost data 709 thereof.

The performance of the system configuration elements and the cost thereof stored in the cost data memory unit 105 can be added, deleted and modified by means of the input unit 114. Further, in the embodiment of the present invention, it is supposed that the auxiliary storage capacity is sufficient and difference in cost depending on the storage capacity is not considered for simplification of description.

FIG. 6 shows structure of the system configuration data stored in the system configuration memory unit 106. The system configuration data is stored in the system configuration memory unit 106 for each of the computers 110 to be performance-guaranteed.

The system configuration data 601 of the computer system 1 shown in FIG. 6 includes data concerning the number of CPUs 602, CPU processing performance 603, main memory capacity 604, I/O processing speed 605 and paging time per page 606. The paging time 606 represents an average time per page required for page-in and page-out in main memory management of the virtual memory system and difference in time required for page-in and page-out is not considered for simplification of description.

The system configuration data 601 is collected by the supervisory server 113 from the computers 110 to be performance-guaranteed and is transferred to the configuration deriving apparatus 101, which stores the system configuration data 601 in the system configuration memory unit 106.

The job data memory unit 107 stores data (job data) relative to jobs executed by the computers 110 to be performance-guaranteed. The job data is collected by the supervisory server 113 from the computers 110 to be performance-guaranteed and is transferred to the configuration deriving apparatus 101, which stores the job data in the job data memory unit 107.

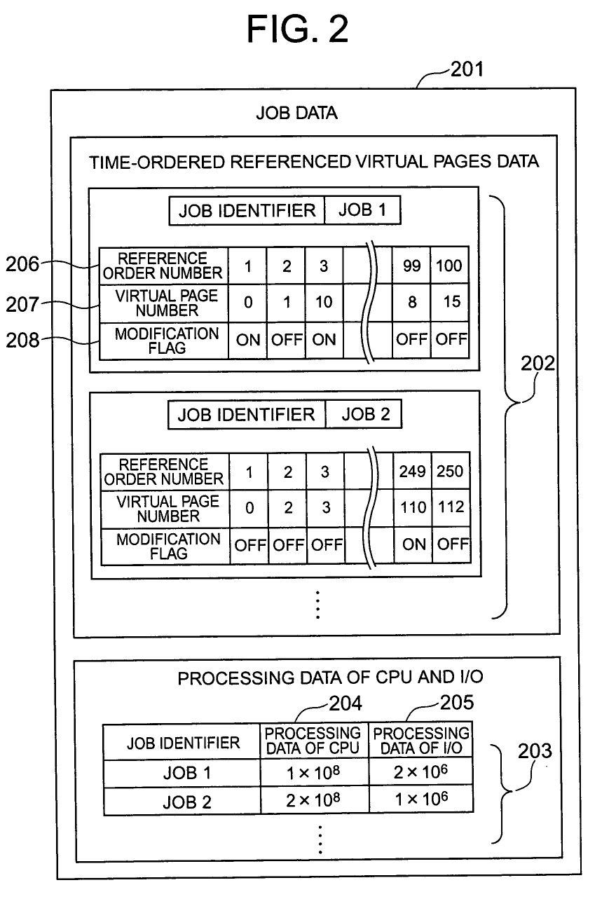

FIG. 2 shows structure of the job data stored in the job data memory unit 107. The job data 201 includes time-ordered referenced virtual pages data 202 and processing amount data 203 of CPU and I/O.

The processing amount data 203 of CPU and I/O includes CPU processing amount 204 which is a product of CPU processing time required for one execution of job and CPU processing speed and I/O processing amount 205 which is a product of I/O processing speed and I/O processing time in one execution of job when the number of simultaneously-executed jobs is 1.

The processing amount data 203 of CPU and I/O can be calculated by using the value of the CPU processing performance and the value of the I/O processing speed of the system configuration data stored in the system configuration memory unit 106 of FIG. 1 and the processing time data of CPU and I/O received from the supervisory server 113.

The time-ordered referenced virtual pages data 202 is constituted by virtual page numbers 207 referred to in virtual memory, which are recorded in corresponding manner to reference order numbers 206 according to the elapse of time, and whether contents of the referred virtual page are modified or not is recorded by a modification flag 208. The time-ordered referenced virtual pages data 202 and the processing amount data 203 of CPU and I/O are provided by ones for each of job identifiers for identifying the jobs.

The configuration deriving unit 102 has the function of deriving a system configuration having the minimum cost from system configurations having the probability for all the processing requests, which is equal to or lower than B, of the processing having the response time from issuing of a processing request to end of its processing equal to or longer than A in the transaction processing of a designated job in a designated computer 110 to be performance-guaranteed. Hereinafter, symbol A is used to represent the response time of transaction and symbol B is used to represent the probability having the response time equal to or longer than A.

In the embodiment of the present invention, the job data is acquired from the computer system being in execution of transaction processing and the optimal system configuration of the target is derived. However, the configuration deriving unit 102 can operated as far as only job data is inputted. The present invention not only can improve performance of the computer system already being operated but also can apply to the case where a system is first constructed.

FIG. 3 is a flowchart showing processing operation of the configuration deriving unit 102. The processing operation of the configuration deriving unit is now described with reference to FIG. 3.

(1) The configuration deriving unit 102 first reads in the system identifier and the job identifier from the input unit 114 and further reads in two values set for the computer 110 of the object 109 to be performance-guaranteed, that is, the response time A of transaction and the probability B that the processing time of transaction exceeds the response time A (step S301).

(2) The configuration deriving unit 102 next reads in job data corresponding to the job of the object to be performance-guaranteed from the job data memory unit. 107 (step S302).

(3) The configuration deriving apparatus 101 reads in the system configuration data collected by the supervisory server 113 from the computers 110 to be performance-guaranteed and to be transferred to the configuration deriving apparatus 101 and stores the data in the system configuration memory unit 106 (step S303).

(4) The configuration deriving unit 102 utilizes the time-ordered referenced virtual pages data of the job data shown in FIG. 2 and calculates virtual page reference interval probability distribution having as random variable the number of other difference virtual pages referred to until the referred page is referred to again. This calculation method is described later (step S304).

(5) The configuration deriving apparatus 101 reads in the occurrence rate (arrival rate) of the job processing requests in the computers 110 to be performance-guaranteed, collected by the supervisory server 113 from the computers 110 to be performance-guaranteed and transferred to the configuration deriving apparatus 101, from the arrival rate memory unit 108 (step S305).

(6) The configuration deriving unit 102 derives a cost function from cost data read out from the cost data memory unit 107. This deriving method is described later (step S306).

(7) The system configuration (optimal solution) in which the probability having the processing time of transaction exceeding the response time A is equal to or lower than the probability B and the cost thereof is minimum is calculated by the numerical analysis method using the Lagrange multipliers method. Detail of the optimal solution deriving method is described later (step S307).

(8) The configuration deriving unit 102 judges whether the optimal solution is found in the processing in step S307 or not and when it is not found, this processing is ended (steps S308, S311).

(9) When the optimal solution is found in step S308, the probability having the response time equal to or longer than A is calculated (step S309).

(10) A parameter set, the cost and the probability having the response time equal to or longer than A, of the optimized system configuration are outputted to the output unit 115 and this processing is ended (steps S310, S311).

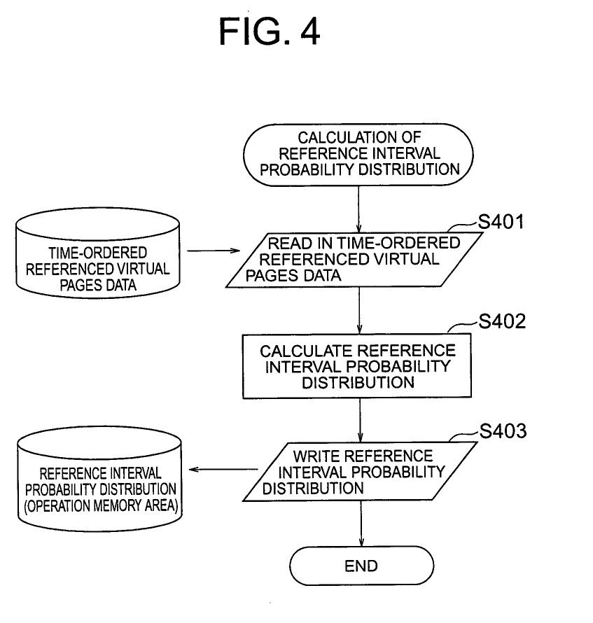

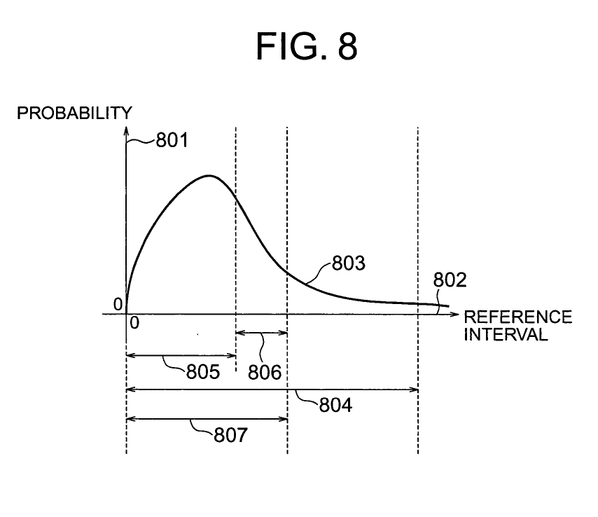

FIG. 4 is a flowchart showing processing operation of calculating the virtual page reference interval probability distribution in step S304 of FIG. 3. This processing operation is now described. The probability described here as the virtual page reference interval probability is referred to as “Distance Probability”. Although described later, the graph 803 in FIG. 8 shows an example of the virtual page reference interval probability distribution expressing the relation of reference interval 802 and probability 801.

(1) Data of relevant job identifier is read in from the time-ordered referenced virtual pages data (202 of FIG. 2) stored in the job data memory unit 107 (step S401).

(2) The probability distribution (virtual page reference interval probability distribution) having as the random variable the number of other difference virtual pages (reference interval) to be referred to during the time from reference of a page by utilization of the time-ordered referenced virtual pages data until the same page is first referred again is calculated (step S402).

(3) The virtual page reference interval probability distribution calculated in step S402 is recorded in a temporary memory area which is an operation memory area (step S403).

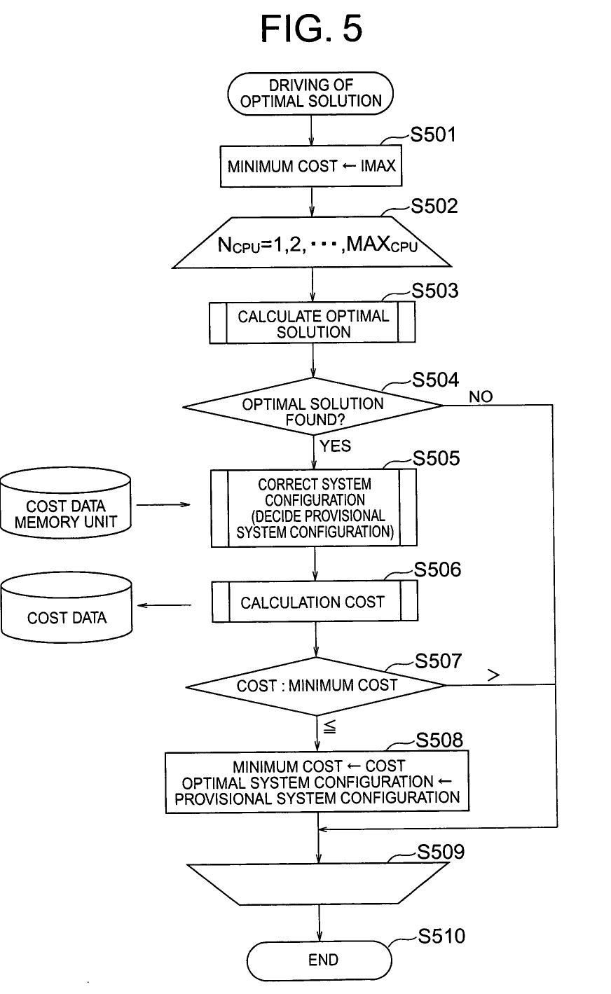

FIG. 5 is a flowchart showing processing operation of deriving the optimal solution in step S307 of FIG. 3. This processing operation is now described.

(1) First, the maximum positive integer Iₘₐₓ (large value that does not exist as a cost) is set to a variable “lowest cost” (step S501).

(2) The number of CPUs N_{CPU} is increased from one to MAX_{CPU} (the maximum number of increasable CPUs). Each time the number of CPUs N_{CPU} is set or increased, processing from step S503 to step S509 described later is executed. When the number N_{CPU} is larger than the maximum number MAX_{CPU}, the processing proceeds to step S510 described later (step S502).

(3) The optimal solution of the parameter set of the optimal system configuration is calculated. This calculation method is described later (step S503).

(4) In step S503, it is judged whether the optimal solution is founded or not and when it is found, the cost data in the cost data memory unit 105 is used to correct the parameter set of the system configuration. That is, the actual parameter set nearest to the system configuration parameter set obtained in step S503 is searched for. This searching method is described later. The obtained parameter set is set as a provisional system configuration parameter set (steps S504 and S505).

(5) The cost in the system parameter set calculated in step S505 is calculated and it is judged whether the calculated cost is equal to or lower than a value of the variable “lowest cost” or not (steps S506 and S507).

(6) In the judgment of step S507, when the calculated cost is equal to or lower than the value of the variable “lowest cost”, the cost calculated in step S505 is set to the variable “lowest cost” and the provisional system configuration parameter set at that time is set as the optimal system configuration parameter set (step S508).

(7) When the optimal solution is not found in step S504 or when the cost calculated in step S507 is not equal to or lower than the value of the variable “lowest cost” or when all processing is ended for the number of CPUs N_{CPU} from one to MAX_{CPU} after the processing of step S508, the processing is ended (step S509 and S510).

In the above-mentioned processing, the case where the value of the variable “lowest cost” is equal to I_{MAX} means that the optimal solution does not exist.

The processing operation of calculating the probability (P[t>A]) having the response time equal to or longer than A is now described. In this description, for clarification of description, the memory areas which are not present in the working set in the main memory area utilizable by the user are supposed to be all managed by OS as available frames.

The working set is a main memory area which is fixedly assigned to each job. Setting and modification of the magnitude of the working set can be easily made by using a general-purpose computer OS, for example. The page-in operation is performed when the page to be referred to is not present in the working set and the page reclaim cannot be performed. The page reclaim function is general as the function provided in the operating system (OS) of the virtual memory system.

Further, in the embodiment of the present invention, data of the execution time of CPU and the processing time of I/O in execution of the job is obtained by measurement thereof using the performance measurement apparatus when the job is executed, while it is not necessarily necessary that the job is executed actually and it is also possible to predict the CPU processing amount and the I/O processing amount from the execution program used in the job.

The probability (P[t>A]) having the response time equal to or longer than A can be calculated by the following two steps:

Step 1: Predictive Calculation of Average Service Time

The probability distribution of the time (service time) from beginning of the required processing to end thereof is calculated as exponential service having 1/μ_{NJ} of the following equation (1) as the average service time.

$$\frac{1}{μ {N}_{j}} = {T}_{CPU} + {T}_{1 / 0 , {N}_{J}} + {T}_{paging , {N}_{J}} ≡ {T}_{NJ} \qquad ( 1 )$$

In the equation (1), μ_{NJ} represents the number of processing requests (service rate) processed in a unit time by one CPU when N_{J} jobs are executed simultaneously. Further, T_{CPU} represents the processing time of CPU required to process the job one time. By changing the processing performance of the CPU from S_{old} to S, the CPU processing time T_{CPU} is changed to S_{old}S⁻¹T_{CPU} as shown by the following equation (2):

T_{CPU}→S_{old}S⁻¹T_{CPU} (2)

Further, in the equation (1), T_{I/O},N_{J} represents the waiting time of CPU per one execution of job due to I/O waiting when N_{J} jobs are executed simultaneously. The I/O waiting time T_{I/O},N_{J} does not contain the I/O time by paging. Further, the time T_{I/O},N_{J} can be predictively calculated from the following equation (3) representing the I/O processing rate R_{I/O} in one execution of job when the number of jobs to be executed simultaneously is one and the following equation (4) derived from the equation (3).

$$\begin{matrix}{R}_{I / O} ≡ \frac{{T}_{I / O} ( I / O Processing Time Except Paging ) }{{T}_{CPU} ( CPU Processing Time ) + {T}_{I / O} ( I / O Processing Time Except paging ) } , \\ where \\ CPU Processing Time \text{:} {T}_{CPU} = \frac{{A}_{CPU} ( CPU Processing Amount )}{S ( CPU Processing Speed )} , \\ I / O Processing Time \text{:} {T}_{I / O} = \frac{{A}_{I / O} ( I / O Processing Amount )}{I ( I / O Processing Speed )} ,\end{matrix} \qquad ( 3 )$$

$$\begin{matrix}\frac{{T}_{CPU}}{{T}_{CPU} + {T}_{I / O , {N}_{J}}} = 1 - {( {R}_{I / O} )}^{{N}_{J}} \\ or \\ {T}_{I / O , {N}_{J}} = \frac{{( {R}_{I / O} )}^{{N}_{J}} \cdot {T}_{CPU}}{1 - {( {R}_{I / O} )}^{{N}_{J}}}\end{matrix} \qquad ( 4 )$$

The T_{I/O} is changed to I_{old}I⁻¹Y_{I/O} as shown by the following equation (5) by changing the I/O processing speed from I_{old} to I due to change of I/O configuration.

T_{I/O}→I_{old}I⁻¹T_{I/O} (5)

Further, T_{paging}, N_{J} in the equation (1) represents the I/O time by paging when N_{J} jobs are processed simultaneously. This calculation procedure is described later.

Step 2: Calculation of Probability (P[t>A]) Having Response Time Equal to or Longer Than A

In the embodiment of the present invention, one CPU can execute a plurality of N_{J} jobs simultaneously in the multiprogramming manner. In the embodiment, since the queuing theory is applied, predictive calculation is made by regarding the system having N_{CPU} CPUs and capable of executing N_{J} jobs simultaneously as the system having N_{CPU} CPUs and the service rate μ_{NJ}.

Actually, when the number of simultaneously-executable jobs N_{J} is larger than 1 and the number of requests being in waiting state, containing state in which execution is being made, is smaller than the number of simultaneously-executable jobs N_{J}, the service rate is changed depending on the number of processing requests being in waiting state and accordingly the service rate is not fixed temporally.

In the embodiment, the number of simultaneously-executable jobs N_{J} is decided by means of optimization described later and accordingly even if the actual service rate is not fixed temporally, approximation is made using the fixed value μ_{NJ} as the service rate.

The probability Pₖ in case where the number of requests being in waiting state and containing the number of states in which processing is being made is k in the system having N_{CPU} CPUs and capable of executing N_{J} jobs simultaneously is expressed by the following equation (6) in accordance with the queuing theory.

$$\begin{matrix}{P}_{K} = \frac{{( {a}_{NJ} )}^{K}}{k !} {P}_{0} ( 0 \leq k \leq {N}_{CPU} ) , \\ {P}_{k} ≡ {\tilde{P}}_{k} ≡ \frac{{( {N}_{CPU} )}^{{N}_{CPU}} {( {p}_{NJ} )}^{k}}{{N}_{CPU} !} {P}_{0} ( {N}_{CPU} < k ) \\ {P}_{0} = {( {\sum }_{k = 0}^{{N}_{CPU} - 1} \frac{{( {a}_{NJ} )}^{k}}{k !} + \frac{{( {a}_{NJ} )}^{{N}_{CPU}}}{( {N}_{CPU} - 1 ) ! ( {N}_{CPU} - {a}_{NJ} )} )}^{- 1} \\ where \\ {a}_{NJ} = \frac{λ}{{μ}_{NJ}} , {p}_{NJ} = \frac{λ}{{N}_{CPU} {μ}_{NJ}} .\end{matrix} \qquad ( 6 )$$

Accordingly, in the system having N_{CPU} CPUs and capable of executing N_{J} jobs simultaneously, the probability having the waiting time equal to or longer than T is expressed by the following equation (7):

$$\begin{matrix}{P}_{q} [ t > T ] = {\sum }_{k = 1}^{∞} \{ ( Probability Having k Requests in System ) \times \\ ( {\sum }_{g = 0}^{k - 1} ( Probability that Processing for s Requests is Ended within Time T ) \} \\ = {\sum }_{k = 1}^{∞} \{ {P}_{k} ( {\sum }_{s = 0}^{K - 1} \frac{{( {N}_{{CPU}_{μ NJT}} )}^{s}}{s !} {ⅇ}^{- {N}_{{CPU}_{μ NJ}} T} ) \} \\ = {\sum }_{s = 0}^{{N}_{CPU} - 1} {\sum }_{K = s + 1}^{{N}_{CPU}} \cdot \frac{{λ}^{k} \cdot {( {μ}_{NJ} )}^{s - k} \cdot {( {N}_{CPU} T )}^{s}}{k ! \cdot s !} \cdot {P}_{0} {ⅇ}^{- {N}_{{CPU}_{μ NJ }} T} + \\ \frac{{( {N}_{CPU} )}^{{N}_{CPU}}}{{N}_{CPU} !} \frac{1}{{N}_{CPU} \cdot {μ}_{{N}_{s}} - 1} \cdot {P}_{0} {ⅇ}^{- ( {N}_{CPU} \cdot {μ}_{NJ} - 1 ) \cdot T}\end{matrix} \qquad ( 7 )$$

The response time is calculated by using the waiting time in accordance with the following equation:

Response Time=Waiting Time+Execution Time

By replacing the execution time by the average execution time 1/μ_{NJ}, the probability having the response time equal to or longer than A can be calculated by the following equation (8):

P[t>A]=P_{q}└t>(A−μ_{NJ}⁻¹)┘ (8)

Next, the procedure of predictively calculating the time required for paging from the time-ordered referenced virtual pages data is described.

In the embodiment of the present invention, it is supposed that main memory management of the computer to be performance-guaranteed is made by the virtual memory system, swapping is not considered and there is no page for which paging cannot be made (fixed page). Further, it is supposed that a plurality of jobs executed by the computer to be performance-guaranteed are to be executed by the same program and the result of execution of job depends on only input information. It is supposed that the virtual page reference interval probability distribution is not different largely in the processing of each job.

Expansion to the system in which the virtual page reference interval probability distribution is largely different in each of jobs can be also applied to the embodiment by using the probability distribution obtained by averaging the virtual page reference interval probability distribution of the jobs, although not shown in the embodiment of the present invention. When the real page corresponding to the virtual page to be referred to is in the working set, the page-in processing is not required. Further, even when the real page corresponding to the virtual page to be referred to is not in the working set, the available frame managed by the operating system is utilized by the page reclaim function again and the page-in processing is not performed if contents of necessary page are left in the available frame managed by the operating system without modification.

When a certain page is now referred to, the referred page is not deleted from the working set at once even if another page is referred to thereafter. When vacancy is lost from the working set, one available page is taken out from the available frame queue and the frame having the largest interval (LRU) from the reference made just before in the working set is enqueued in the available frame queue and deleted from the working set.

The page-out is performed only when contents of a frame taken out from the available frame are required to be written into an auxiliary storage unit at the time that the frame is taken out from the available frame for the purpose excluding the page reclaim. “To be required to be written” means that (1) there is a corresponding frame in the auxiliary storage unit and its contents are different from contents of the frame in the main memory unit or (2) there is no corresponding frame in the auxiliary storage unit and the frame is required to be referred to again.

The number of pages requiring the paging during execution of the job can be predictively calculated and the time required for the paging can be calculated by using the probability referred to as the virtual page reference interval probability in consideration of the foregoing. In this connection, re-utilization or reclaim of the frame by the page reclaim is not contained in the paging.

When the number of other different virtual pages referred to during the time from reference of the virtual page of the i-th reference order number 206 of the time-ordered referenced virtual pages data 202 shown in FIG. 2 until that page is first referred to again is d, the virtual page reference interval D(i) corresponding thereto is defined by D(i)≡d and when that page is not referred to again, it is defined by D(i)≡∞.

The probability P(d) having the virtual page reference interval of d is defined by the following equation (9) from the population M={D(i)|iεall of virtual page referenced time-order numbers}.

$$P ( d ) = \frac{Number of Elements d in Population M }{Total of Population M} \qquad ( 9 )$$

FIG. 8 shows an example of the probability distribution of the virtual page reference interval probability. As shown by this example, the probability that the page referred to once is referred again in a short time is high according to a property called “locality of references”.

In the embodiment of the present invention, it is supposed that each CPU includes an independent main memory unit and the OS is operated in each CPU independently. Accordingly, the computer to be performance-guaranteed may be replaced by a plurality of systems including the same system configuration and connected to one another by means of a network apparatus or the like.

In one CPU, a value (number of pages) obtaining by dividing a memory capacity Mᵤₛₑᵣ (hereinafter referred to as an available memory capacity) obtained by subtracting a memory capacity M_{fix} required for basic software such as OS from the whole memory capacity M, by a memory capacity per virtual page is dᵤₛₑᵣ and the number of pages of the working set is d_{working set}. At this time, the value dᵤₛₑᵣ is expressed by the following equation (10):

$${d}_{user} = \frac{M - {M}_{fix}}{B ( Main Memory Capacity of Unit Frame ) } = \frac{{M}_{user}}{B} \qquad ( 10 )$$

In the case of a tightly coupled multiprocessor system in which a plurality of CPUs share one main memory unit and only one OS is operating, a memory capacity per CPU may be used as M and a memory capacity for the basic software per CPU may be used as M_{fix}.

In FIG. 8, section 804 represents the number of all the available pages dᵤₛₑᵣ, section 805 the number of pages of the working set d_{working set} and section 806 the value obtained by dividing the number of all the available frames by the number of simultaneously-executed jobs N_{J} as follows:

(dᵤₛₑᵣ−N_{J}d_{working set})/N_{J}

In the embodiment of the present invention, the page-out processing is performed only when the available frame is utilized for the purposes excluding reclaim and contents of the frame are changed to be required to be written in the auxiliary storage unit.

Accordingly, when the reference interval from reference of a certain page until the page is next referred to again is equal to or smaller than dᵤₛₑᵣ+(dᵤₛₑᵣ−N_{J}d_{working set})/N_{J}(=dᵤₛₑᵣ/N_{J}) or the reference interval is equal to or smaller than the interval of the section 807 of FIG. 8, the page-in is not performed since contents of the page are left in the real memory even when the page is referred again.

When the number of CPUs is 1 and the number of simultaneously-executed jobs is 1, all of the available memory is used for the relevant jobs and accordingly the page-in probability is expressed by the following equation (11) as the probability that the relevant pages are not stored in the main memory.

$${P}_{Page in} = 1 - {\sum }_{d = 1}^{{d}_{user}} P ( d ) \qquad ( 11 )$$

Further, the page-out probability is expressed by the following equation (12) using the probability that contents of the page are changed as P_{change} in the job processing.

P_{page out}−P_{change}P_{page in} (12)

P_{change} is calculated by the following equation (13) by using it as the probability that the page contents modification flag 208 of the time-ordered referenced virtual pages data 204 is on.

$${P}_{change} = \frac{Total of Modification Flags in ON in Referenced Pages Data}{Length of Time - ordered Referenced Virtual Pages Data} \qquad ( 13 )$$

This probability can be calculated more exactly by calculating the probability distribution that the number of other different virtual pages referred to from the time that contents of the page are modified until the page is first referred to again is used as the random variable.

When N_{J} jobs are executed simultaneously, the page-in probability can be predictively calculated by the following equation (14) if it is supposed that the number of pages of the working set is d_{working set} and available pages except the working set are held as available frame group.

$${P}_{Page in} = 1 - {\sum }_{d = 0}^{\frac{{d}_{user}}{{N}_{J}}} P ( d ) \qquad ( 14 )$$

When the optimal system configuration is derived by the Lagrange multipliers method, the above probability is expressed by an integral form of the probability density as shown in the following equation (15):

$${P}_{page i n} = 1 - {\int }_{0}^{{d}_{user} / {N}_{j}} \hat{P} ( m ) ⅆ m \qquad ( 15 )$$

The integrand function is defined by P([m]), where [m] is a maximum integer which does not exceed a real number m.

Further, the page-out occurrence probability can be predictively calculated by the following equation (16).

P_{page out}=P_{change}P_{page in} (16)

The time spent for paging in one execution of job is calculated by the following equation (17) where time required for page-in of one page and time required for page-out of one page are t_{page in} and t_{page out}, respectively.

T_{paging}=L₁(t_{page in}·P_{page in}+t_{page out}·P_{page out})+L₂·t_{page in} (17)

In the equation (17), the last term represents the time required for reading of the first page in the virtual page to be referred to. L₁ represents a length of time-ordered referenced virtual pages data (last number in virtual page reference order) and L₂ represents the number of virtual pages for the job execution program read in the main memory area from the auxiliary storage unit mainly.

In the embodiment of the present invention, L₂ is calculated as a value obtained by subtracting the number of references that the modification flag is “ON” in the first reference from the total of different virtual pages in the time-ordered referenced virtual pages data.

Rough calculation is made by defining that the virtual page that the modification flag is “ON” in the first reference is the page secured dynamically in the job execution program and the virtual page that the modification flag is “OFF” in the first reference is the page for storing the program.

In the embodiment of the present invention, the paging time is predicted by the following equation (18) on condition that t_{page in} is equal to t_{page out}.

T_{paging}=L₁·t_{paging}·P_{page in}(1+P_{change})+L₂·t_{paging}

where

P_{paging}≡P_{page in}=P_{page out}, /t_{paging}=t_{page in}=t_{page out} (18)

Further, in the embodiment of the present invention, it is supposed that there is no delay time due to the page reclaim processing in case where the page is not in the working set and the page reclaim is possible as compared with the case where the page is in the working set.

Even when the delay time due to the page reclaim cannot be neglected, the time required for the page reclaim per page can be measured to thereby predictively calculate the time required for the page reclaim in the job execution.

The method of selecting the system configuration (optimal solution) having the minimum cost on condition that the probability having the response time equal to or longer than A is equal to or lower than B is now described in detail.

To select the system configuration having the minimum cost on condition that the probability having the response time equal to or longer than A is equal to or lower than B is identical with the search for the system configuration in which a performance function F=F(s₁, s₂, . . . , sₙ) for representing performance by using system configuration data (s₁, s₂, . . . , sₙ) for a certain value C satisfies a restraint F≦C and a cost function G=G(s₁, s₂, . . . , sₙ) functioning as an objective function is minimized.

The system configuration parameters in the embodiment of the present invention include processing performance S of CPU, the number of CPUs N_{CPU}, whole memory capacity M, I/O processing speed I and the number of simultaneously-executable jobs N₃ and the constraint F≦C corresponds to the condition that the probability having the response time equal to or longer than A is equal to or lower than B. The condition that the probability having the response time equal to or longer than A is equal to or lower than B is given by the following equation (19):

P[t>A]=P_{q}└t>(A−μ_{NJ}⁻¹)┘≦B (19)

As described later, the number of simultaneously-executable jobs N_{J} is not a variable independent of other system variables on account of the condition for the optimal solution.

The cost function for representing the cost is a function that dispersed cost data can be reproduced and is expressed by the following equation (20):

G=g_{CPU}(S,N_{CPU})+g_{memory}(N_{CPU}M)+g_{I/O}(I) (20)

For simplification of description, when the cost of N_{CPU} CPUs is assumed to be equal to N_{CPU} multiplied by the cost of one CPU, the cost function g_{CPU} of the CPU is expressed by the following equation (21):

g_{CPU}(S,N_{CPU})=N_{CPU}·g_{CPU}(C,1)≡N_{CPU}·g_{CPU}(C) (21)

The cost function g_{CPU} of the CPU, the cost function g_{memory} of the main memory unit and the cost function g_{I/O} of the auxiliary storage unit can be obtained by the parameter-fitting method or the like.

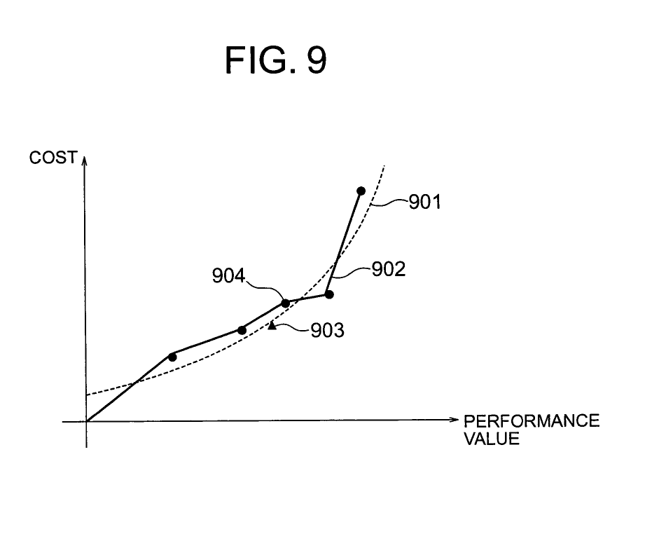

FIG. 9 shows an example of a graph representing the relation of performance and cost. Each of the above cost functions is obtained as an approximate curve of distribution of cost and performance as shown by 901 of FIG. 9, for example. The function form is expressed by a sum of one-variable continuous function, for example, as shown by the following equation (22):

g(s)=g+gs+gs²+ (22)

The function form (quadratic, cubic polynomial, logarithmic function and the like) pertinent to the approximate curve depends on the cost function of system configuration elements.

In decision of the function, if the differential equation g′(s) satisfies the condition g′(s)≧0(s>0) even for undetermined characteristic, the result of the optimal system configuration is not largely influenced and accordingly it may be the function expressed by polygonal lines, for example, as shown by 902 of FIG. 9.

The cost function is generally an increasing function for system configuration variables (s₁, s₂, . . . , sₙ) and accordingly the constraint for deriving the system configuration satisfying the equation (19) and minimizing the cost is sufficient if it is replaced as shown by the following equation (23) (constraint (i)).

P_{q}└t>(A−μ_{N}_{_{J}}⁻¹)┘=B (23)

The system configuration parameters (CPU processing performance S, number of CPUs N_{CPU}, whole memory capacity M, I/O processing speed I and number of simultaneously-executable jobs N_{J}) are independent except the number of jobs N_{J}.

The number of simultaneously-executed jobs N_{J} is decided as N_{J} that maximizes the probability P_{q}[t>(A−μ_{NJ}⁻¹)].That is, N_{J} is decided as a solution of the following equation (24) for given system variables (S, N_{CPU}, M, I)

$$\frac{ⅆ}{ⅆ {N}_{j}} {P}_{q} [ t > ( A - {μ}_{{N}_{j}}^{- 1} ) ] = 0 \qquad ( 24 )$$

In foregoing, the value N_{J} described on the left side of the equation (23) is a value of N_{J} that is a solution of the equation (24) (constraint (ii)).

In order to obtain the optimal system, the Lagrange multipliers method is used to select the system configuration having the minimum cost function G operating as the objective function under the constraints (i) and (ii).

The parameter set (S, M, I) of the optimal system configuration in case where the number N_{CPU} of CPUs is fixed is obtained by solving the following (4+2) equations (26) obtained from the function U of the following equation (25) in which Lagrange multipliers λ₁ and λ₂ are introduced to thereby calculate the local minimum of the function U.

$$\begin{matrix}U = G ( {a}_{1} , {s}_{2} , ⋯ , {s}_{n} ) + {λ}_{1} ( B - {P}_{q} ⌊ t > ( A - {μ}_{{N}_{j}}^{- 1} ) ⌋ ) + {λ}_{2} ( \frac{\partial }{\partial {N}_{J}} {P}_{q} [ t > ( A - {μ}_{{N}_{j}}^{- 1} ) ] ) & ( 25 ) \\ \partial U / \partial {s}_{i} = 0 ( {s}_{i} = S , M , I , {N}_{j} , {λ}_{1} , {λ}_{2} ) , & ( 26 )\end{matrix}$$

The system configuration corresponding to the parameter set (S, M, I) in the local minimum of the solution is the optimized system configuration in case where the given number of CPUs is N_{CPU}.

In order to decide the system configuration containing the number of CPUs, the system configuration optimized for each number of CPUs is derived while increasing the number N_{CPU} of CPUs from one to the maximum increasable number thereof, so that the parameter set (N_{CPU}, S, M, I) of the system configuration having the lowest cost is decided from the optimized system configurations derived above.

The solution of the equation (26) can be calculated from a numerical value obtained by utilizing the method of successive approximation by the Newton's method that is often used in the nonlinear programming method or the like.

In the Newton's method, the above-mentioned function U is applied with Tayler's expansion about the parameter s^{c}=(s^{c}ᵢ) of the system configuration as shown by the equation (27).

$$U ( {s}^{c} + Δ s ) = U ( {s}^{c} ) + \sum \frac{\partial U}{\partial {s}_{i}} {{\vert}_{s = {s}^{c}} Δ {s}_{i} + \sum \sum \frac{{\partial }^{2} U}{\partial {s}_{i} \partial {s}_{j}} \vert}_{s = {s}^{c}} Δ {s}_{i} Δ {s}_{j} \qquad ( 27 )$$

In order to calculate the minimum value in the proximity of the above parameter s^{c}, a vector V and a matrix Q shown by the equations (28) are calculated.

$${V}^{c} = ( \frac{\partial U}{\partial {s}_{i}} {\vert}_{s = {s}^{c}} ) , {Q}^{c} = ( \frac{{\partial }^{2} U}{\partial {s}_{i} \partial {s}_{j}} {\vert}_{s = {s}^{c}} ) \qquad ( 28 )$$

In the equation (27), Δs for minimizing the function U is expressed by the following equation (29):

Δs=(−1)·(Q^{c})⁻¹·V^{c} (29)

In order to calculate the minimum value of the target, a value of (s^{c}+Δs^{c}) is set to s^{c} and the processing of calculating the minimum value solution of the Taylor's expansion is repeated until the solution is converged, that is, the magnitude of Δs is reduced to zero or can be regarded as zero.

Since the solution (optimal system configuration parameter set) of the equation (26) is different from a selectable parameter set of the system configuration having a dispersed value, it is necessary to select the actually usable parameter set of the system configuration nearest to the optimal parameter set of the system configuration expressed by the continuous real number calculated.

Therefore, the processing of correcting the system configuration in step S505 in the deriving processing of the optimal solution explained in FIG. 5 searches for the actual system configuration parameter set having the nearest distance between the calculated system configuration parameter set (s₁, s₂, . . . , sₙ) and the system configuration parameter set (s′₁, s′₂, . . . , s′ₙ) existing in the cost data actually.

Accordingly, in the embodiment of the present invention, system configuration data s′ᵢ in which s′ᵢ≧sᵢ and s′ᵢ−sᵢ is minimum with respect to system variables sᵢ (i=1, 2, . . . , n) is searched the cost data for to thereby decide the optimized actual system configuration parameter set (s′₁, s′₂, . . . , s′ₙ).

For example, in FIG. 9, when the optimal solution is represented by coordinates of 903, the system configuration element represented by 904 is the optimized system configuration element.

The method of deriving the optimized system configuration can be utilized as the method of deciding performance values of system configuration elements when the system configuration elements are developed in order to construct the system in which the probability having the response time equal to or longer than A is equal to or smaller than B and the cost is lowest.

In the embodiment, it is premised that the plurality of CPUs as the system configuration have the same processing performance. It is difficult to predict the response time by the queuing theory in the environment including the plurality of CPUs having different processing performance, while even in such case the calculation method using simulation can be used to predict the response time.

Next, as a second embodiment of the present invention, there is described an example that the cost data is utilized to judge whether the condition of the equation (19) is satisfied or not for all combinations of system parameters and the combination having the lowest cost is searched the combinations satisfying the condition for to thereby obtain the optimal solution. The second embodiment is particularly effective for the case where the number of combinations of the system configuration elements is small. Further, the system configuration of the second embodiment may be the same as that of FIG. 1.

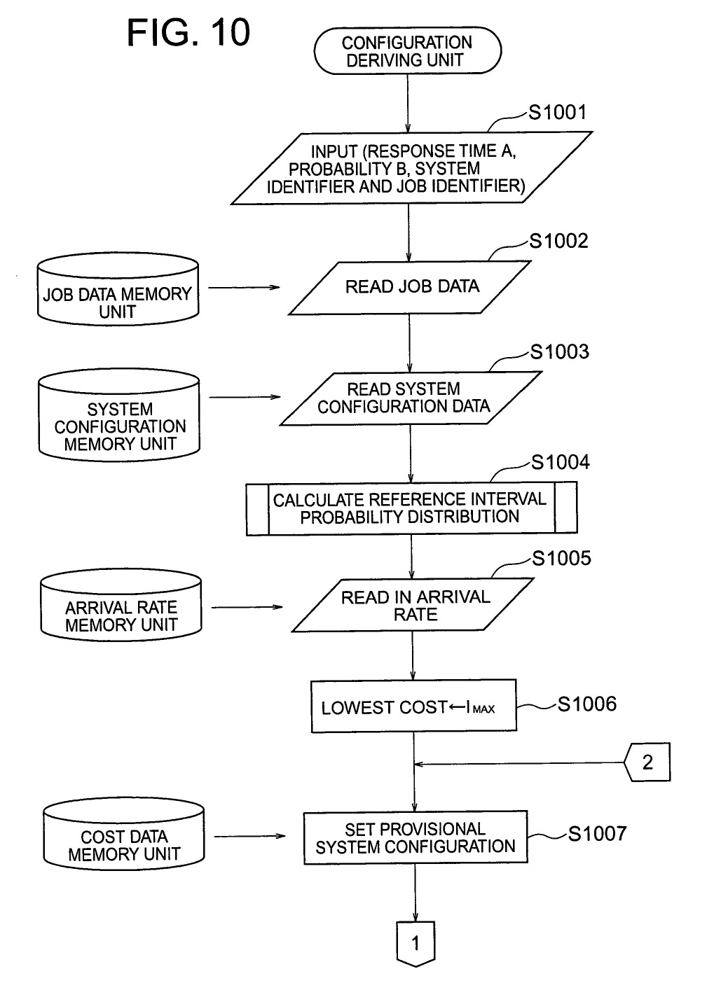

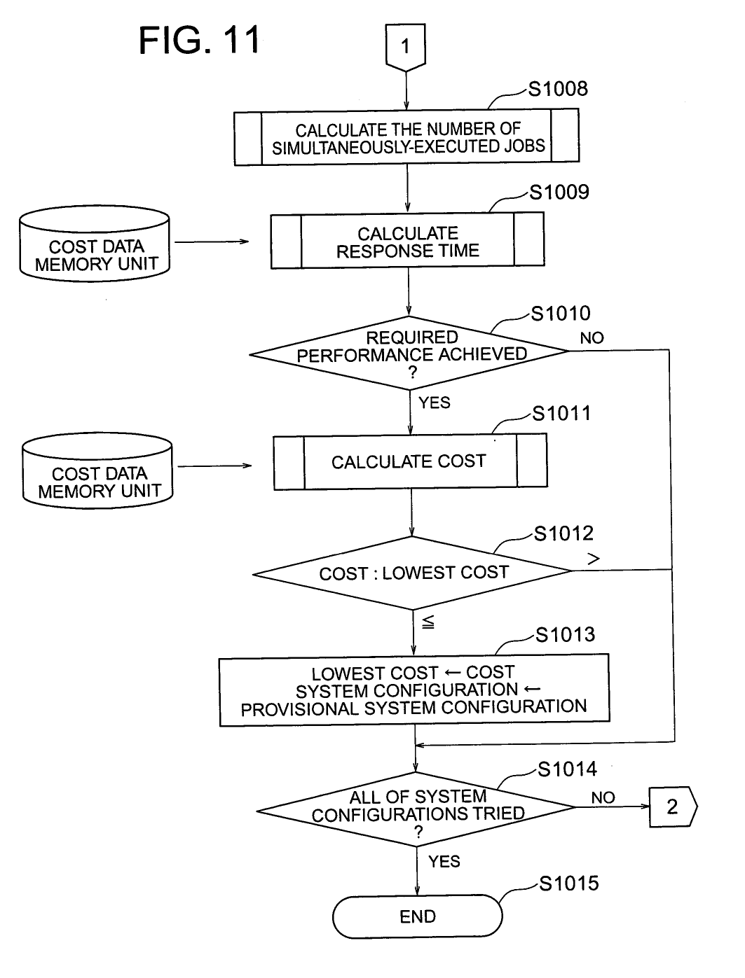

Referring now to FIGS. 10 and 11, processing operation of the configuration deriving unit of the second embodiment of the present invention is described.

(1) The configuration deriving unit 102 first reads in the system identifier, the job identifier and two values set to the computers to be performance-guaranteed of the computer group 109, for example, the computer 110 to be performance-guaranteed, that is, the response time A of transaction and the probability B having the processing time of transaction exceeding the response time A from the input unit 114 (step S1001).

(2) The configuration deriving unit 102 next reads in the job data corresponding to the job to be performance-guaranteed from the job data memory unit 107 (step S1002).

(3) The configuration deriving apparatus 101 reads in the system configuration data which the supervisory server 113 acquires from the computer to be performance-guaranteed 110 and is transferred to the configuration deriving apparatus 101 and stores the data in the system configuration memory unit 106 (step S1003).

(4) The configuration deriving unit 102 utilizes the time-ordered referenced virtual pages data of the job data shown in FIG. 2 to calculate the virtual page reference interval probability distribution in which the number of other different virtual pages referred until the referred page is referred again is used as the probability distribution (step S1004).

(5) The configuration deriving apparatus 101 reads in the occurrence rate (arrival rate) of the job processing request in the computer to be performance-guaranteed which the supervisory server 113 acquires from the computer to be performance-guaranteed 110 and is transferred to the configuration deriving apparatus 101 (step S1005).

(6) Next, a value I_{MAX} is set to a variable “lowest cost”. The value I_{MAX} is an maximum positive number which can be expressed by the computer (step S1006).

(7) In order to judge whether the probability having the response time equal to or longer than A is equal to or lower than B or not for all combinations of the parameter set of the system configuration, the non-judged parameter set of the system configuration (provisional system configuration) constituted by the cost data of system configuration elements contained in the cost data is selected (step S1007).

(8) In the provisional system configuration selected in step S1007, the number of simultaneously-executed jobs that the probability having the response time equal to or longer than A is minimized and the probability thereof are calculated (step S1008).

(9) The equations (7) and (8) are used to calculate the probability having the response time equal to or longer than A (step S1009).

(10) It is judged whether the probability calculated in step S1009 is equal to or lower than B and when the calculated probability is not equal to or lower than B, the processing proceeds to step S1014 described later (step S1010).

(11) When the calculated probability is equal to or lower than B in the judgment of step S1010, the costs of the system configuration elements are read in from the cost data and the total of the costs is calculated (step S1011).

(12) It is judged whether the total cost calculated in step S1011 is smaller than the value of the variable “lowest cost” or not and when the calculated total cost is larger than the value of the variable “lower cost”, the processing proceeds to step S1014 described later (step S1012).

(13) In the judgment of step S1012, when the calculated total cost is smaller than the value of the variable “lowest cost”, the cost calculated in step S1011 is set to the variable “lowest cost” and the provisional system configuration parameter set corresponding thereto is set as the system configuration parameter set (step S1013).

(14) It is judged whether all of the system configuration parameter sets which can be constructed from the cost data are tried or not. When all of the system configuration parameter sets are not tried, the processing subsequent to step S1007 is repeated in order to decide the next provisional system configuration parameter set. When all of the system configuration parameter sets are tried, the processing operation of the configuration deriving unit is ended (steps S1014 and S1015).

In the above-mentioned processing, when the variable “cost” is not I_{MAX}, the system configuration which satisfies the performance condition and minimizes the cost is present and the system configuration parameter set corresponding thereto is set to the “system configuration”.

Further, there are the following two methods as the calculation procedure of the cost in the step S1011. That is, (i) a cost calculation method in case where a quite new system is introduced and (ii) a cost calculation method in case where an existing system is expanded to be utilized. In the case of (ii), for example, when it is assumed that the number of CPUs is 3 for the provisional system configuration and 2 for the existing system and the main memory capacity is 2GB for the provisional system configuration and is 1GB for the existing system, the cost for one (=3−2) CPU and the main memory capacity of one (=2−1) GB may be calculated.

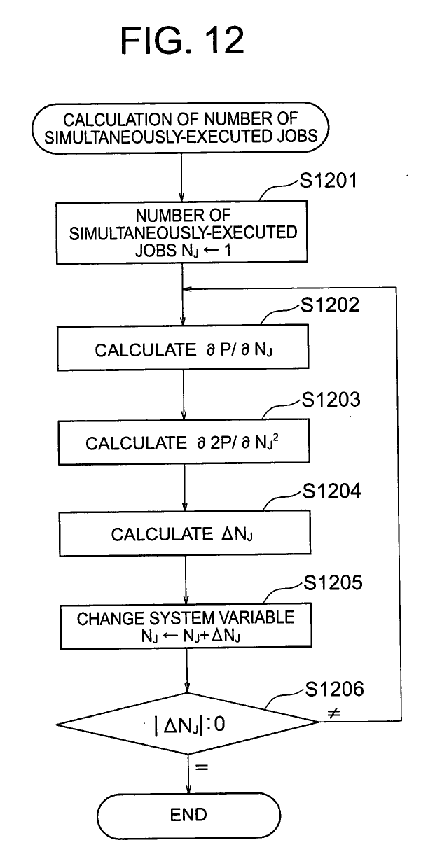

FIG. 12 is a flowchart showing the processing of calculating the number of simultaneously executed jobs in step S1008 of FIG. 11. This processing is now described.

(1) 1 is set to the variable N_{J} of the number of simultaneously-executed jobs as its initial value (step S1201).

(2) A partial derivative of P[t>(A−μ_{NJ}⁻¹)] described later with respect to the number N_{J} of simultaneously-executed jobs is calculated (step S1202).

(3) A second partial derivative of P[t>(A−μ_{NJ}⁻¹)] with respect to the number N_{J} of simultaneously-executed jobs is calculated (step S1203).

(4) ΔN_{J} is calculated. The partial derivative F1 calculated in step S1202 and the second partial derivative F2 calculated in step S1203 are used to calculate ΔN_{J}=−(F1/F2) (step S1204).

(5) ΔN_{J} calculated in step S1204 is added to the variable N_{J} to update N_{J} (step S1205).

(6) convergence is judged and when the solution is converged, the processing of calculating the number of simultaneously-executed jobs is ended. When the magnitude |ΔN_{J}| of ΔN_{J} is zero or approaches to zero sufficiently, it is judged that the solution is converged. Here, to approach to zero sufficiently means that, for example, |ΔN_{J}|/|N_{J}|<10⁻⁴ is satisfied (step S1206).

Next, as third and fourth embodiments of the present invention, there is described an example of the method and system for dynamically changing the system configuration so that the probability having the response time equal to or longer than A is equal to or lower than B by utilizing the optimal system configuration data outputted by the configuration deriving apparatus.

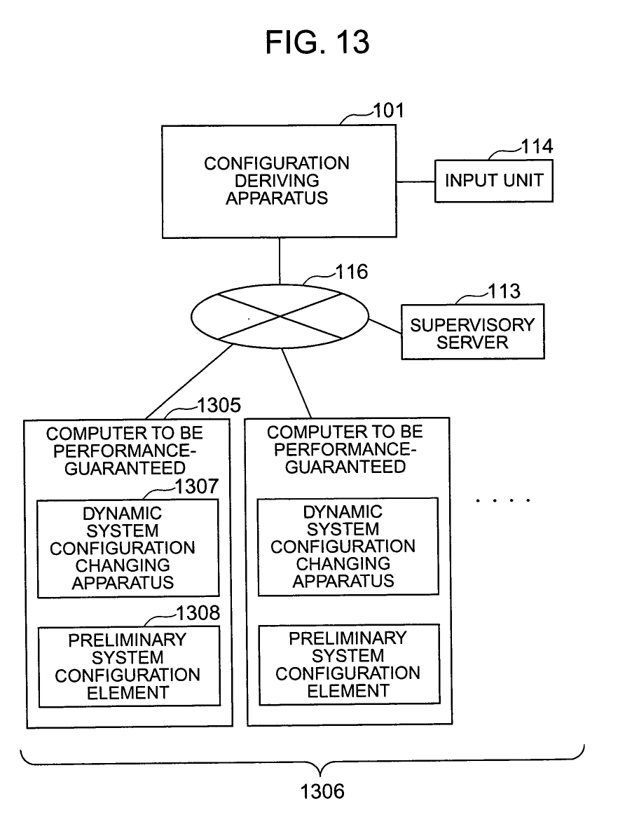

FIG. 13 is a block diagram showing the configuration of the third embodiment of the present invention in case where the computer to be performance-guaranteed includes preliminary system configuration elements. In FIG. 13, numeral 1305 denotes a computer to be performance-guaranteed, 1306 a computer group to be performance-guaranteed, 1307 a dynamic system configuration changing apparatus, 1308 a preliminary system configuration element, and other reference numerals are the same as FIG. 1.

The third embodiment of the present invention shown in FIG. 13 is different from the first embodiment shown in FIG. 1 in that the computers 1305 to be performance-guaranteed of the computer group 1306 to be performance-guaranteed each include the dynamic system configuration changing apparatus 1307 and the preliminary system configuration element 1308.

The preliminary system configuration element 1308 is a system configuration element which does not perform the job processing to be performance-guaranteed. Further, the dynamic system configuration changing apparatus 1307, when received a request, adds the preliminary system configuration element to the system configuration element in order to execute the job processing to be performance-guaranteed.

As described above, the function of switching the physically-connected system configuration element to a usable state or an unusable state is known as “capacity on demand” or “capacity reserved”.

The configuration deriving apparatus 101 transmits the optimal system configuration data to the dynamic system configuration changing apparatus 1307 of the computer to be performance-guaranteed. The dynamic system configuration changing apparatus 1307, when received the optimal system configuration data, operates the preliminary system configuration in order to execute the job processing and realize the system configuration. The preliminary system configuration element is constituted by one or two or more CPUs or a main memory unit or the like.

In the third embodiment of the present invention, it is supposed that billing or accounting is made in accordance with the number of CPUs used, the capacity of main memory used, the use time thereof or the like. The dynamic system configuration changing apparatus 1307 can start or stop the preliminary system configuration element to thereby change the number of CPUs and the main memory capacity of the computer to be performance-guaranteed without stopping of the system.

In the third embodiment of the present invention, the configuration deriving apparatus 101 utilizes the network 116 to transmit the optimal system configuration information to the dynamic system configuration changing apparatus 1307 provided in the computer to be performance-guaranteed instead of outputting the optimal system configuration information from the output unit 115.

The dynamic system configuration changing apparatus 1307 receives the optimal system configuration information transmitted by the system configuration deriving apparatus 101 and dynamically changes the system configuration in accordance with the information.

Accordingly, in the third embodiment of the present invention, the system configuration can be changed dynamically so that the probability having the response time equal to or longer than A is equal to or lower than B while an accounting amount required therefor can be suppressed to the minimum.

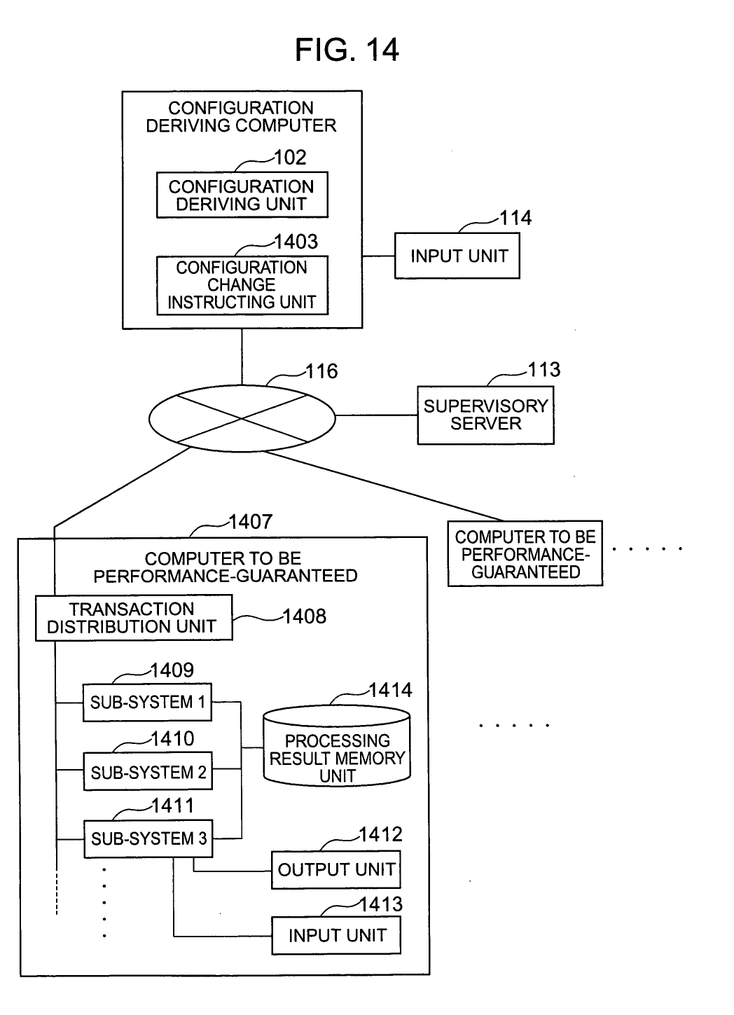

FIG. 14 is a block diagram showing a fourth embodiment of the present invention in case where one computer to be performance-guaranteed is constituted by a plurality of sub-systems. In FIG. 14, numeral 1403 denotes a configuration change instructing unit, 1407 a computer to be performance-guaranteed, 1408 a transaction distribution unit, 1409 to 1411 sub-systems 1 to 3, 1412 an output unit, 1413 an input unit, 1414 a processing result memory unit and other reference numerals are the same as FIG. 1.

The fourth embodiment of the present invention shown in FIG. 14 is different from the first embodiment shown in FIG. 1 in that the configuration deriving apparatus 101 includes the configuration change instructing unit 1403 in addition to the configuration deriving unit 102 and the computer 1407 to be performance-guaranteed includes the transaction distribution unit 1408, the sub-systems 1409 to 1411, the output unit 1412, the input unit 1413 and the processing result memory unit 1414.

The sub-systems are classified into those utilized for job processing of the object to be performance-guaranteed and those utilized for applications other than it. Here, it is supposed that, for example, the sub-system 1409 performs job processing of the object to be performance-guaranteed, the sub-systems 1410 and 1411 do not perform job processing of the object to be performance-guaranteed, the sub-system 1410 is not used for application other than the job processing and the sub-system 1411 is utilized for application other than the job processing.

The sub-system group composed of the sub-systems 1409 to 1411 may be a physically independent computer group connected to one another through network function. At this time, users of all the sub-systems of the sub-system group may not be the same. Further, the sub-systems of the fourth embodiment of the present invention each have identical system configuration and processing ability.

The configuration deriving unit of the fourth embodiment of the present invention utilizes the function of the “response time calculation unit” to calculate the number of sub-systems required for realizing the required performance. In this case, the function of the “response time calculation unit” is utilized to calculate the first number of sub-systems satisfying the condition that the probability having the response time equal to or longer than A is equal to or lower than B while increasing the number of sub-systems one by one. The processing of calculating the response time is merely repeated until the target performance is attained and accordingly the processing is facilitated as compared with the first embodiment.

In the fourth embodiment of the present invention described below, the sub-system utilized for the purpose other than the job processing is named a preliminary sub-system. Further, the user of the preliminary sub-system may be different from a person who performs the job to be performance-guaranteed. The preliminary sub-systems are classified into the sub-systems (charged sub-systems) which require to make accounting to the person who performs the job to be performance-guaranteed or to make remittance to an owner when the sub-systems are used for job processing and the sub-systems (free sub-systems) which do not require. Whether the sub-system is the free sub-system or the charged sub-system can be identified with reference to a sub-system table provided in the configuration deriving apparatus.

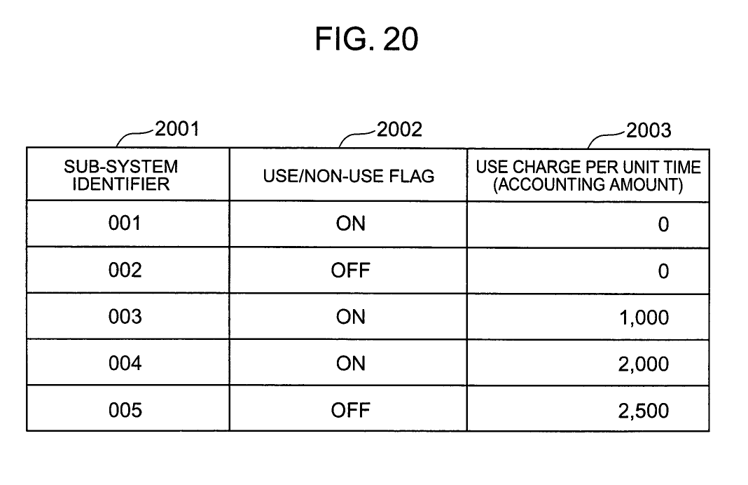

FIG. 20 shows structure of the sub-system table. The sub-systems are identified by sub-system identifiers 2001. The table includes use/non-use flag 2002 indicating whether the sub-system is in use or not and use charge per unit time information 2003 for each of the sub-systems.

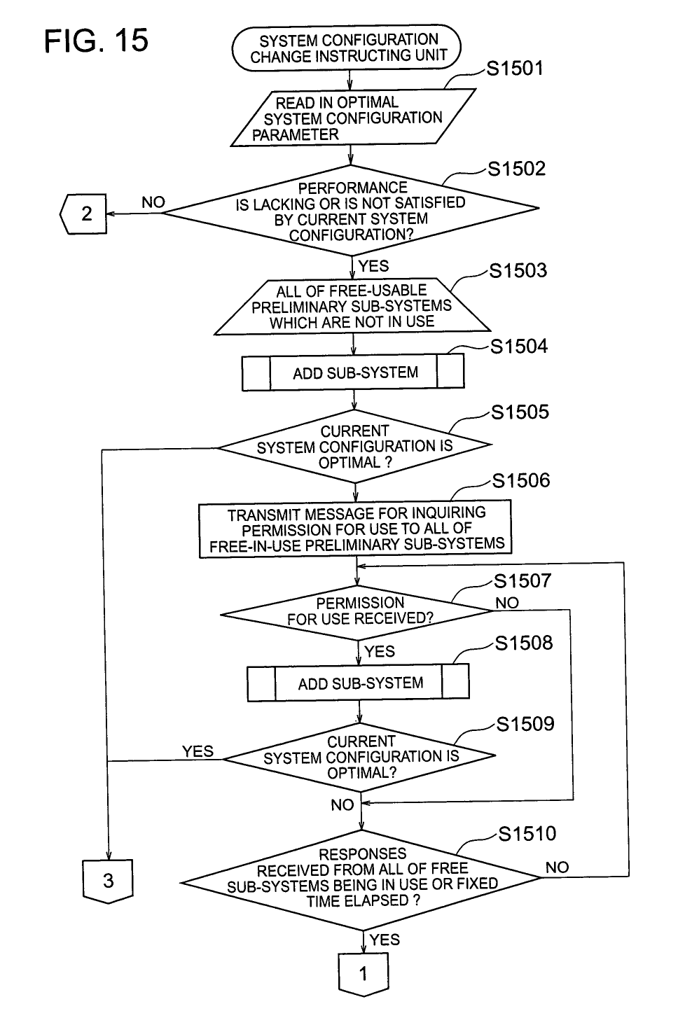

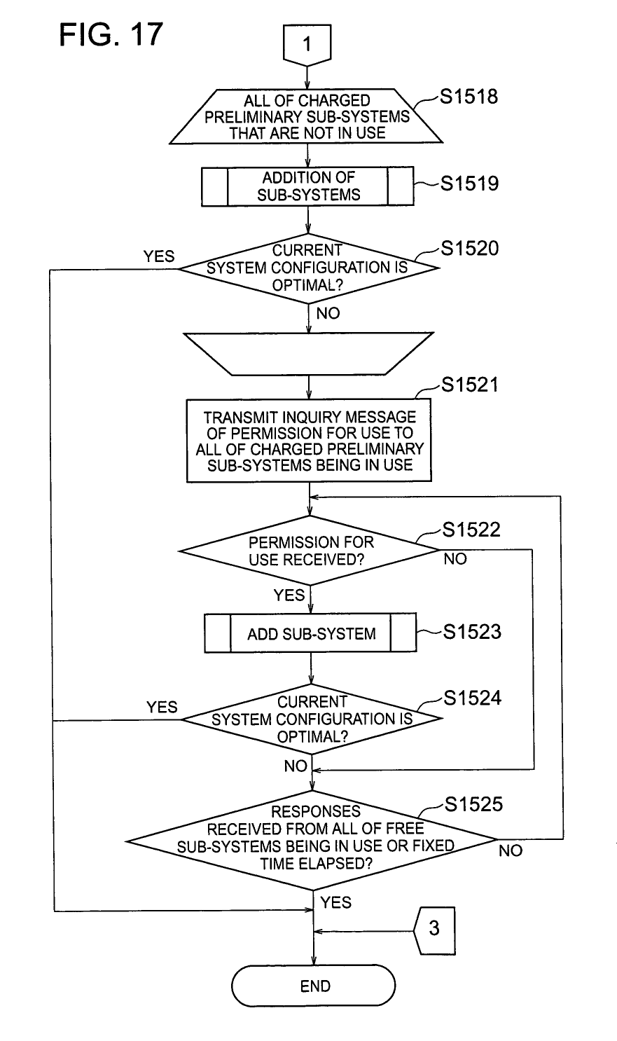

FIGS. 15 to 17 are flowchart showing processing operation of the system change instructing unit of the fourth embodiment of the present invention. This processing operation is now described.

(1) The optimal system configuration parameter outputted by the configuration deriving unit 102 is read in and the target number of sub-systems to be added is decided (step S1501).

(2) The optimal system configuration parameter read in step S1501 is compared with the current system configuration parameter to judge whether performance is lacking or is not or satisfied by the current system configuration parameter or not. When it is not lacking, the processing proceeds to step S1511 described later (step S1502).

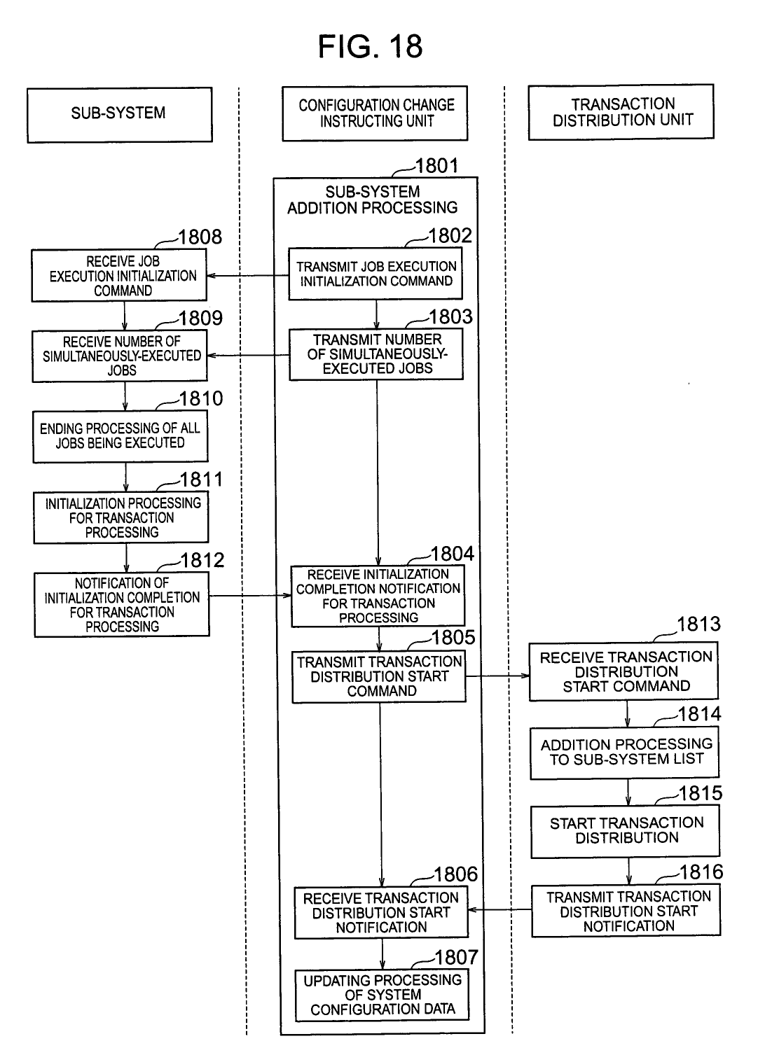

(3) In the judgment of step S1502, when the performance is lacking or is not satisfied by the current system configuration parameter, all the free-usable preliminary sub-systems which are not in use are selected to be added to the current system configuration. Detailed processing of adding the sub-systems is described later with reference to FIG. 18 (steps S1503 and S1504).

(4) It is judged whether the number of sub-systems increased by addition of the sub-systems reaches the target value and the current system configuration is optimal or not and when it reaches the target value, this processing is ended (step S1505).

(5) In the judgment of step S1505, when the target value is not reached, the output units of all the preliminary sub-systems which is free during use are caused to display a permissible request for use and a message for inquiring the permission for use is transmitted to the owner or the like (step S1506).

(6) It is judged whether there is permission for use of the sub-system from the owner or the like of the preliminary system which is free during use in response to the inquiry of the permission for use or not and when the permission for use is inputted, addition processing of the sub-system is performed (steps S1507 and S1508).

(7) It is judged whether the number of sub-systems increased by addition of the sub-system reaches the target value and the current system configuration is optimal or not. When the target value is reached, this processing is ended (step S1509).

(8) When the target value is not reached in the judgment of step S1509 or when the permission for use is not obtained in the judgment of step S1507, it is judged whether a fixed time elapses after transmission of the inquiry message in step S1506 or not or whether responses to all the inquiries are received or not. When the fixed time does not elapse or when all the responses to the inquiries are not yet received, the processing is returned to step S1507 to repeat the same processing. Further, when the fixed time has elapsed and the responses to all the inquiries have been received, the processing proceeds to the processing subsequent to step S1518 described later (step S1510).

(9) In judgment of step S1511, when performance is not lacking or is satisfied by the current system configuration parameter, it is judged whether the current system configuration has excessive performance or not and when it does not have excessive performance, this processing is ended (step S1511).

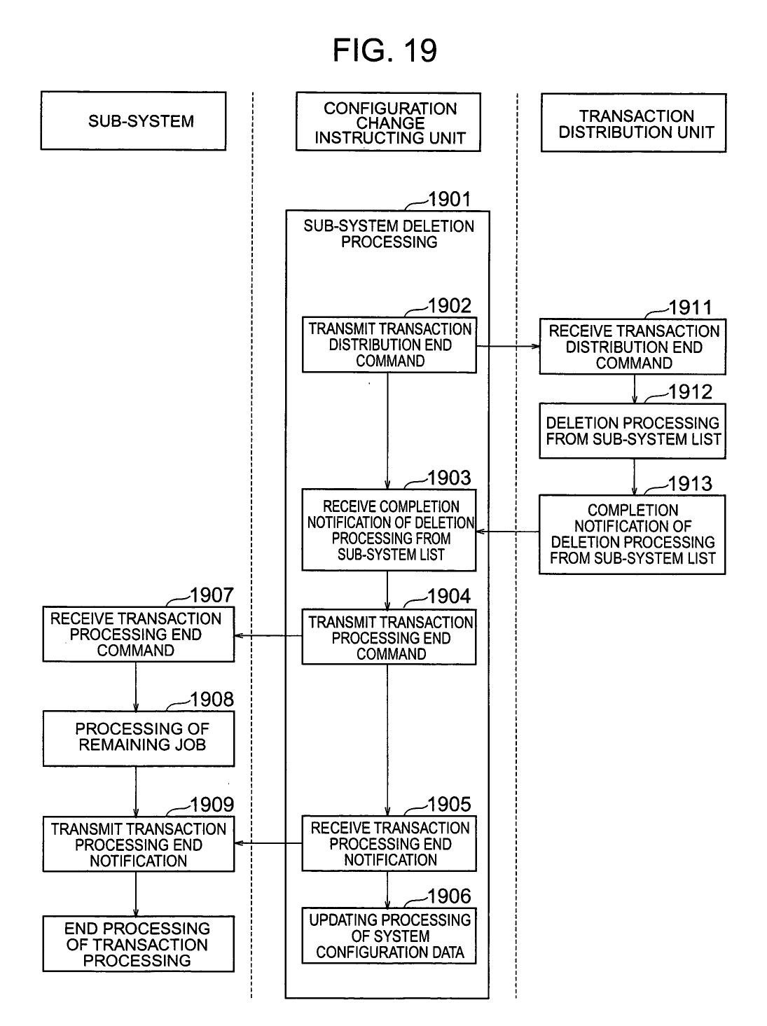

(10) All of the charged sub-systems which are not used in the current system configuration are set to execute the processing of steps S1513 and S1514 to perform deletion processing of the charged sub-system. Detailed deletion processing is described later with reference to FIG. 19 (steps S1512 and S1513).

(11) It is judged whether the number of sub-systems reduced by deletion of the sub-system reaches the target value or not and whether the current system configuration is optimal or not. When the target value is reached, this processing is ended (step S1514).

(12) After the processing for all the charged sub-systems, when the target value is not reached in the judgment of step S1514, all the free sub-systems which are not used in the current system configuration are set to execute processing of steps S1516 and S1517, so that deletion processing of the free sub-system is performed (steps S1515 and S1516).

(13) It is judged whether the number of sub-systems reduced by deletion of the sub-system reaches the target value or not and whether the current system configuration is optimal or not. When the target value is reached, this processing is ended. Further, even after the processing for all the free sub-systems, when the target value is not also reached, this processing is ended (step S1517).

(14) In the judgment of step S1510, when the fixed time has elapsed and the response to all the inquiries have been received, all the charged preliminary sub-systems which are not in use are set to execute processing of steps S1519 and S1520, so that addition processing of the charged sub-system is performed (steps S1518 and S1519).

(15) It is judged whether the number of sub-systems reaches the target value and the current system configuration is optimal or not. When the target value is reached, this processing is ended (step S1520).

(16) In the judgment of step S1520, when the target value is not reached, the output units of all the charged preliminary sub-systems being in use are caused to display a permissible request for use and a message for inquiring the permission for use is transmitted to the owner or the like (step S1521).

(17) It is judged whether there is a permission for use of the sub-system from the owner or the like of the charged preliminary system being in use in response to the inquiry of the permission for use or not. When the permission for use is inputted, addition processing of the sub-system is performed (steps S1522 and S1523).

(18) It is judged whether the number of sub-systems increased by addition of the sub-system reaches the target value and the current system configuration is optimal or not. When the target value is reached, this processing is ended (step S1524).

(19) When the target value is not reached in the judgment of step S1524 or when the permission for use is not obtained in the judgment of step S1522, it is judged whether a fixed time elapses after transmission of the inquiry message in step S1521 or not or whether responses to all the inquiries are received or not. When the fixed time does not elapse or when all the responses to the inquiries are not yet received, the processing is returned to step S1522 to repeat the same processing. Further, when the fixed time has elapsed and the responses to all the inquiries have been received, this processing is ended (step S1525).

FIG. 18 is a timing chart showing the sub-system addition processing in the above-mentioned flow. This processing is now described.

(1) The configuration change instructing unit 1403 transmits the job execution initialization command to the preliminary sub-system and then transmits the number of simultaneously-executed jobs thereto (step 1802 and 1803).

(2) When the preliminary sub-system receives data transmitted by the configuration change instructing unit in the processing of steps 1802 and 1803, the preliminary sub-system performs the initialization processing for performing the transaction processing and enters in the waiting state for a processing request as soon as all the processing which is being executed currently has been finished (steps 1808 to 1811).

(3) When the preliminary sub-system completes the initialization processing of its own sub-system, the preliminary sub-system transmits initialization completion notification for transaction processing to the configuration change instructing unit (step 1812).

(4) When the initialization completion notification for transaction processing is received, the configuration change instructing unit transmits transaction distribution start command to the transaction distribution unit 1408 provided in the computer to be performance-guaranteed (steps 1804 and 1805).

(5) When the transaction distribution start command is received, the transaction distribution unit 1408 adds the preliminary sub-system to a sub-system list to thereby start distribution of transaction processing request and transmits the transaction distribution start notification to the configuration change instructing unit (steps 1813 to 1816).

(6) When the transaction distribution start notification is received, the configuration change instructing unit 1403 updates the system configuration data (steps 1806 and 1807).

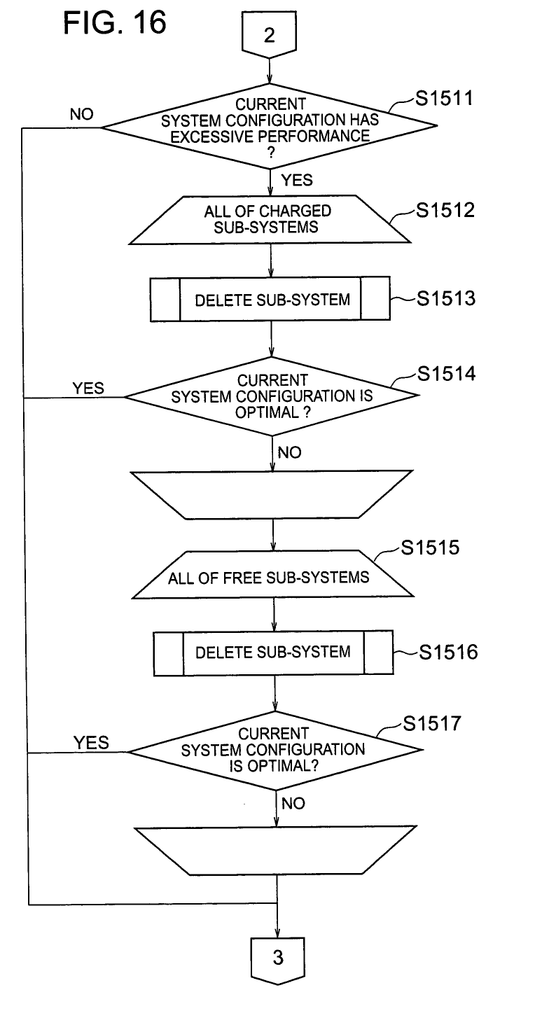

FIG. 19 is a timing chart showing sub-system deletion processing described in the flow of FIG. 16. This processing is now described.

(1) The configuration change instructing unit first transmits transaction distribution end command to the transaction distribution unit in the sub-system deletion processing (step 1902).

(2) The transaction distribution unit receives transaction distribution end command and deletes the sub-system to be deleted from the sub-system list. Further, the transaction distribution unit transmits deletion processing completion notification to the configuration change instructing unit (steps 1911 to 1913).

(3) The configuration change instructing unit receives deletion processing completion notification from the transaction distribution unit to thereby confirm the end of transaction distribution and transmit transaction processing end command to the sub-system (steps 1903 and 1904).

(4) When the transaction processing end command of the configuration change instructing unit is received, the sub-system finishes all the jobs under processing and transmits transaction processing end notification to the configuration change instructing unit to thereby make the end processing of the transaction processing (steps 1907 to 1909).

(5) When the transaction processing end notification is received, the configuration change instructing unit updates the system configuration data (steps 1905 and 1906).

(6) The sub-system addition processing (step 1801 of FIG. 18) and the sub-system deletion processing (step 1901 of FIG. 19) in the configuration change instructing unit dynamically changes the system configuration of the computer to be performance-guaranteed by means of data transmission to and reception from the sub-system, for example, the sub-system 1409 or the transaction distribution unit 1408 shown in FIG. 14.

In the fourth embodiment of the present invention, the charged sub-systems and the free sub-systems are, when not used, classified into sub-systems which can be used without permission and sub-systems which cannot be used without permission. When the processing performance of the computer to be performance-guaranteed is lacking, it is necessary to increase the sub-system for job processing in order to reduce the probability having the response time equal to or longer than A to be equal to or lower than B. In this case, the number of necessary sub-systems is predicted by the above-mentioned method and the preliminary sub-system is used by the procedure described next.

In order to allow the preliminary sub-system group to be used, a message to that effect is transmitted to the preliminary sub-systems. The preliminary sub-systems each receive the message and transmit a message of inquiring whether the sub-system is utilized or not to the output unit to notify the user of the message.

When permission is obtained from the user, the preliminary sub-system is changed to the sub-system for job processing and to cause the sub-system to execute the job.

When the owner of the preliminary sub-system is different from the owner of the sub-system, the use charge per unit time of sub-system is notified to the user.

An amount of money corresponding to the total use amount of the preliminary sub-system is remitted.

Generally, with respect to the response time A of transaction set to the computer 110 to be performance-guaranteed and the probability B having the processing time of transaction exceeding the response time A, a large number of system configurations in which the probability having the response time equal to or longer than A is equal to or lower than B exist as combination of processing performance of CPU, the number of CPUs, the main memory capacity and the like.

Each processing in the embodiment of the present invention can be constructed as a processing program and the processing program can be stored in a recording medium such as HD, DAT, FD, MO, DVD-ROM and CD-ROM to be provided.

Further, in the embodiment of the present invention, the cheapest system configuration is derived from the system configurations in which the probability having the response time equal to or longer than A is equal to or lower than B with respect to given response time A and probability B, although the present invention can derive the cheapest system configuration from the system configurations in which the probability having the response time equal to or shorter than C is equal to or higher than D with respect to given response time C and probability D and further derive the cheapest system configuration from the system configurations in which the probability having the response time equal to or longer than A is equal to or lower than B with respect to given response time A, probability B and arrival rate E of processing request of job.

In the embodiment of the present invention, the system configuration for guaranteeing predetermined processing performance and having the minimum cost can be selected, so that the computer system having necessary processing performance and the minimum cost can be decided automatically in a short time.

Consequently, according to the embodiment of the present invention, since only one system configuration required by the user and having the cheapest cost can be decided, time and labor for decision of the system configuration are not necessary.

As described above, according to the present invention, the system configuration having the minimum cost can be decided automatically in a short time from the system configurations of computers having required processing performance.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A method of deriving a system configuration, comprising:
predicting a response time from issuing of a processing request to end of its processing on the basis of an occurrence frequency of processing requests to computer systems and computer system configurations;
calculating costs of the system configurations on the basis of the system configurations; and
deriving a cheapest system configuration from the system configurations having a probability equal to or lower than B with respect to a given response time A and a probability B given as a probability of processing having a response time equal to or longer then A for all the processing requests.

2. A method of deriving a system configuration, comprising:
predicting a response time from issuing of a processing request to end of its processing on the basis of an occurrence frequency of processing requests to computer systems and computer system configurations;
calculating costs of the system configurations on the basis of the system configurations; and
deriving a cheapest system configuration from the system configurations having a probability equal to or lower than D with respect to a given response time C and a probability D given as a probability of processing having a response time equal to or longer then C for all the processing requests.

3. A method of deriving a system configuration, comprising:
predicting a response time from computer system configurations;
calculating costs of the system configurations; and
deriving a cheapest system configuration from the system configurations in which a probability having a response time equal to or longer than A is equal to or lower than B with respect to a response time A given as a response time from issuing of a processing request to end of its processing, a probability B given as a probability of processing having a response time equal to longer than A for all the processing requests and an arrival rate E of processing requests of jobs.

4. A method of deriving a system configuration, comprising:
predicting a response time from issuing of a processing request to end of its processing on the basis of an occurrence frequency of processing requests to computer systems and computer system configurations;
calculating costs of the system configurations on the basis of the system configurations;
deriving a cheapest system configuration from the system configurations having a probability equal to or lower than B with respect to a given response time A and a probability B of processing having a response time equal to or longer then A for all the processing requests; and
changing the system configuration on the basis of said deriving result dynamically.

5. A method of deriving a system configuration according to claim 4, wherein
said dynamical change of the system configuration is made by starting or stopping a preliminary system configuration element.

6. An apparatus for deriving a system configuration, comprising:
means for predicting a response time from issuing of a processing request to end of its processing on the basis of an occurrence frequency of processing requests to computer systems and computer system configurations;
means for calculating costs of the system configurations on the basis of the system configurations; and
means for deriving a cheapest system configuration from the system configurations in which a probability having a response time equal to or longer than A is equal to or lower than B with respect to a given response time A and a probability B given as a probability of processing having a response time equal to or longer then A for all the processing requests.
